(19) United States
(12) Patent Application Publication
(10) Pub. No.: US 2007/0016893 A1
(43) Pub. Date: Jan. 18, 2007

(54) Tracking resource usage by applications

(75) Inventors: Steven Joseph Branda, Rochester, MN (US); Bhushan Kamlakar Lokhande, Rochester, MN (US); John Joseph Stecher, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/181,716

(22) Filed: Jul. 14, 2005

(51) Int. Cl. G06F 9/44

(52) U.S. Cl. 717/127; 717/115; 717/116; 717/120

(57) ABSTRACT

A method, apparatus, system, and signal-bearing medium that, in an embodiment, create a tag that identifies an application, store the tag in a class of the application, and count a number of times the tag appears in an entry nearest a top of a runtime stack. Counting the number of times the tag appears may include finding an entry nearest a top of a runtime stack that includes the tag and incrementing a count associated with the tag in response to the finding. The creating is performed in response to submission of the application to an application server. In an embodiment, the tag is created based on a cryptographic hash of an archive file that contains the application. In response to a method associated with the class requesting a remote service, the tag is embedded in a remote service request message, which is sent to a remote application server, where the tag is stored in a service class.

### FIELD

This invention generally relates to computer systems and more specifically relates to tracking resource usage by applications.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

One use of these more powerful computer systems is to implement application servers, which execute applications and provide services for security, data access, and persistence. Application servers are often used in an on-demand environment, where customers pay for the application server resources as they consume them. Since an application server may be running multiple applications from multiple customers, the application server needs a low-level mechanism to track the actions of a specific application, so that the application server can determine which resources and how much of these resources the specific application uses. In order to track this resource usage by applications, the application server needs to determine, at runtime, to which application the currently executing code belongs. Making this determination at runtime can be difficult because resources in an application server environment are usually distributed.

Resources are typically distributed in application server environments in two different ways. First, resources are usually distributed among different thread pools inside an application server. For example, separate thread pools typically manage messaging resources, HTTP (Hypertext Transport Protocol) resources, and database resources. Second, application servers can be clustered, thereby distributing resources among many separate computers in a network. Tracking resource usage in these two distributed environments is problematic because only the entry point of a business request to the application server is likely to have enough information to determine which application is servicing the request. This is especially true in cases where the web container and EJB (Enterprise Java Beans) container are split onto different tiers. The code that actually uses the resource may be quite different from the code that acts as the entry point of the request. Hence, determining the application associated with the request by finding the request entry point, which may have executed in a different thread pool or on a different cluster, can be difficult.

One current technique that attempts to track the actions of an application does so by searching for a package name (the name of the group of classes) to which the currently executing code belongs. This technique is utilized by profiling tools that integrate with application servers in order to profile only application code and not the application server code. Unfortunately, this technique relies on the developer of the application to manually implement proper, consistent, and unique naming conventions for the packages that contain the classes of the application. Also, applications that use previously written, or legacy, code have the potential to contain several packages with radically different package names from newly-written package names, which can causes inaccuracies in tracking resource usage by package name. Hence, relying on package names is not necessarily a reliable technique for tracking resource usage by applications.

What is needed is a better technique for tracking resource usage by applications that execute in an application server.

### SUMMARY

A method, apparatus, system, and signal-bearing medium are provided that, in an embodiment, create a tag that identifies an application, store the tag in a class of the application, and count a number of times the tag appears in an entry nearest a top of a runtime stack. Counting the number of times the tag appears may include finding an entry nearest a top of a runtime stack that includes the tag and incrementing a count associated with the tag in response to the finding. The creating is performed in response to submission of the application to an application server. In an embodiment, the tag is created based on a cryptographic hash of an archive file that contains the application. In response to a method associated with the class requesting a remote service, the tag is embedded in a remote service request message, which is sent to a remote application server, where the tag is stored in a service class.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example network of servers, according to an embodiment of the invention.

FIG. 3 depicts a block diagram of tag data, according to an embodiment of the invention.

FIG. 4 depicts a block diagram of an application, according to an embodiment of the invention.

FIG. 5 depicts a block diagram of runtime stacks, according to an embodiment of the invention.

FIG. 6 depicts a flowchart of example processing for generating the tag data, according to an embodiment of the invention.

FIG. 7 depicts a flowchart of example processing for sampling an application server, according to an embodiment of the invention.

FIG. 8 depicts a flowchart of example processing for sampling an application server, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

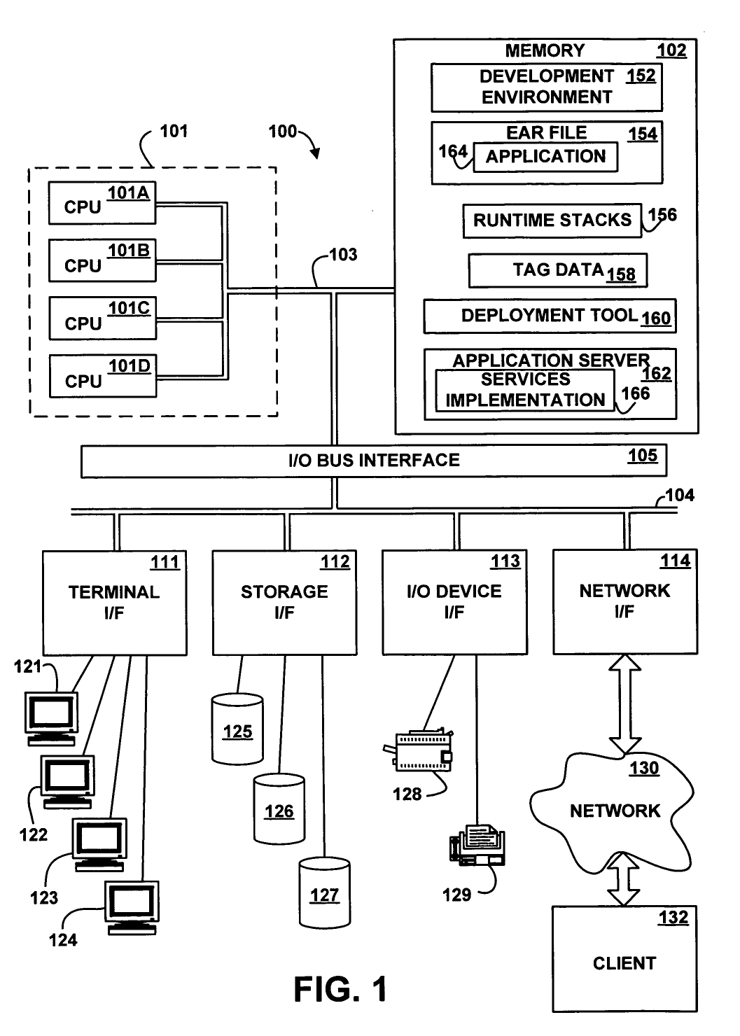

Referring to the Drawings, wherein like numbers denote like parts throughout the several views, FIG. 1 depicts a high-level block diagram representation of a computer system 100 connected via a network 130 to a client 132, according to an embodiment of the present invention. The terms “computer” and “client” are used for convenience only, and an electronic device that acts as a server in one embodiment may act as a client in another embodiment, and vice versa. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes a development environment 152, an ear (Enterprise Archive) file 154, runtime stacks 156, tag data 158, a deployment tool 160, and an application server 162. Although the development environment 152, the ear file 154, the runtime stacks 156, the tag data 158, the deployment tool 160, and the application server 162 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the development environment 152, the ear file 154, the runtime stacks 156, the tag data 158, the deployment tool 160, and the application server 162 are illustrated as being contained within the main memory 102, these elements are not necessarily all completely contained in the same storage device at the same time. Further, although the development environment 152, the ear file 154, the runtime stacks 156, the tag data 158, the deployment tool 160, and the application server 162 are illustrated as being separate entities, in other embodiments some of them, or portions of some of them, may be packaged together.

The development environment 152 is a program that assists a computer programmer, developer, or designer, in developing the ear file 154. The development environment 152 produces the ear file 154 as output. In various embodiments, the development environment 152 may include a source code editor, a compiler and/or interpreter, build-automation tools, a debugger, a version control system, tools to simplify the construction of a GUI (Graphical User Interface), a class browser, an object inspector, and a class hierarchy diagram. In an embodiment, the development environment 152 may be implemented via an enhanced WSAD (Websphere Studio Application Developer), but in another embodiment the development environment 152 may be implemented via any appropriate development environment.

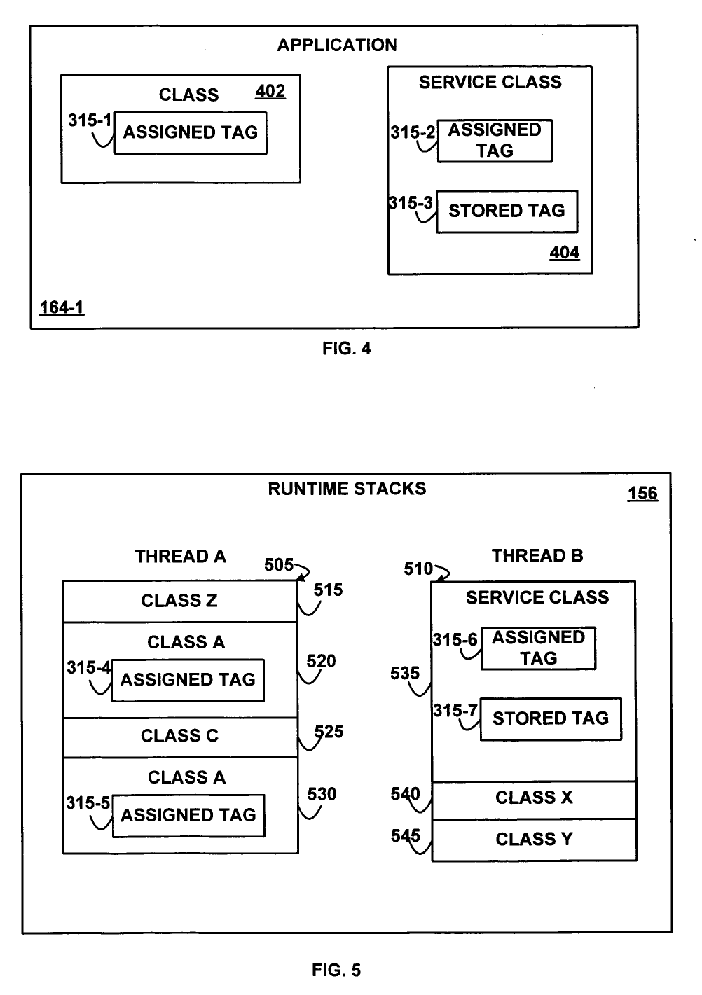

The ear file 154 represents an application 164 that can be deployed to the application server 162 by the deployment tool 160. In an embodiment, the ear file 154 may be implemented as an ear file (Enterprise Archive file) that represents a J2EE (Java 2 Enterprise Edition) application 164 that can be deployed in a WebSphere application server, but in other embodiments any appropriate type of configuration data and any type of application 164 may be used. Ear files are standard Java archive files Oar files) and have the same format. An ear file can consist of one or more web application modules, one or more EJB (Enterprise Java Beans) modules, one or more application client modules, additional jar files required by the application, and any combination thereof. The modules that make up ear files are themselves packaged in archive files specific to their types; for example, a web module contains web archive files and an EJB module contains Java archive files. Ear files also contain a deployment descriptor (e.g., an XML file any other type of descriptor) that describes the contents of the application and contains instructions for the entire application, such as security settings to be used in the run-time environment. The application 164 may be any type of user application, a third-party application, an operating system, or any portion thereof. The application 164 is further described below with reference to FIG. 4.

In an embodiment, the application server 162 is a component-based product (e.g., an enhanced WebSphere product) that resides in the middle-tier of a server-centric architecture and provides middleware services for security and state maintenance, along with data access and persistence. In an embodiment, the application server 162 is a Java application server based on the Java 2 Platform, Enterprise Edition (J2EE), but in other embodiments any appropriate platform may be used. J2EE uses a multi-tier distributed model, which generally includes a client tier, a middle tier, and an EIS (Enterprise Information System) tier. The client tier can be one or more applications or browsers. The J2EE Platform is in the middle tier and consists of a web server and an EJB (Enterprise Java Beans) server. (These servers are also called “containers.”) Additional sub-tiers in the middle tier may also exist. The EIS tier has the existing applications, files, and databases. For the storage of business data, the J2EE platform uses a database that is accessible through a JDBC (Java Database Connectivity), SQLJ (Structured Query Language for Java), or JDO API (Java Data Objects Application Program Interface). The database may be accessible from web components, enterprise beans, and application client components. The application server 162 includes a services implementation 166. In an embodiment, the services implementation 166 may be implemented via an enhanced JVM (Java Virtual Machine), but in other embodiments any appropriate implementation may be used.

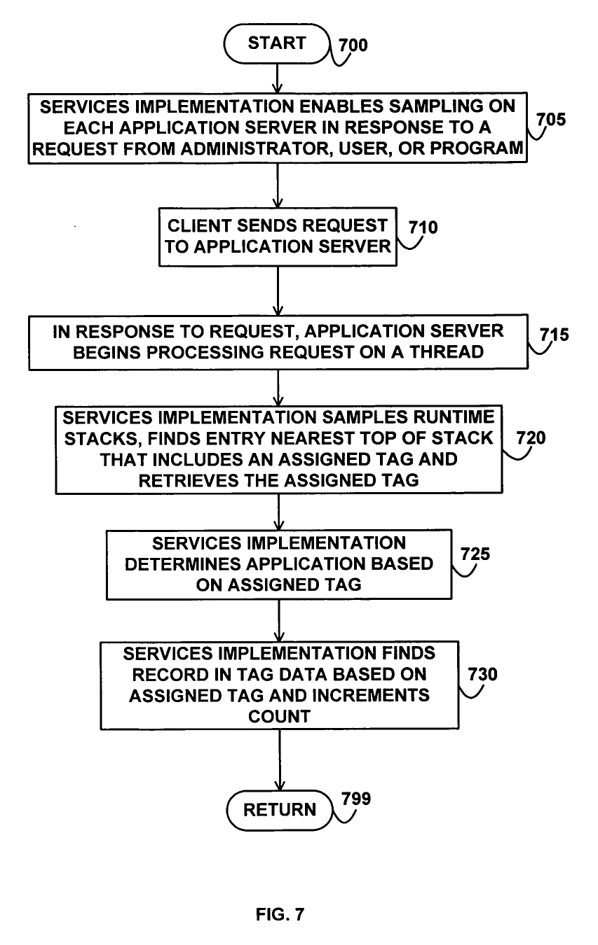

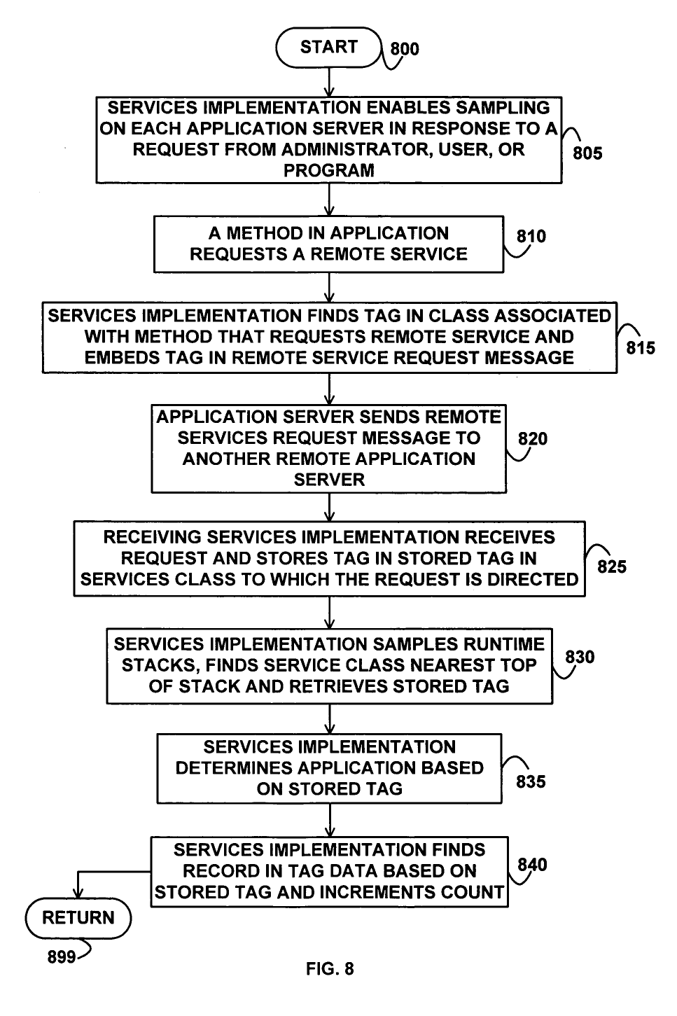

The application server 162 includes instructions capable of executing on the processor 101 or statements capable of being interpreted by instructions executing on the processor 101 to perform the functions as further described below with reference to FIGS. 7 and 8. In another embodiment, the application server 162 may be implemented in microcode or firmware. In another embodiment, the application server 162 may be implemented in hardware via logic gates and/or other appropriate hardware techniques in lieu of or in addition to a processor-based system.

The runtime stacks 156 (also called function stacks, invocation stacks, or call stacks) store information about the functions, subroutines, procedures, methods, and/or classes in the application server 162 and the application 164 that are currently being executed by the processor 101. The runtime stacks 156 are further described below with reference to FIG. 5.

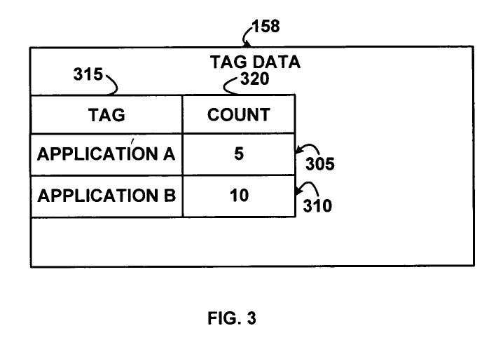

The deployment tool 160 generates a tag unique to the ear file 154 and the application 164, stores the tag in the classes of the application 164, and deploys the application 164 to the application server 162. The application server 162 uses the tag generated by the deployment tool 160, the runtime stacks 156, and the tag data 158 to track resource usage by the application 164. The tag data 158 counts the number of times that the application 164 is executed. The tag data 158 is further described below with reference to FIG. 3.

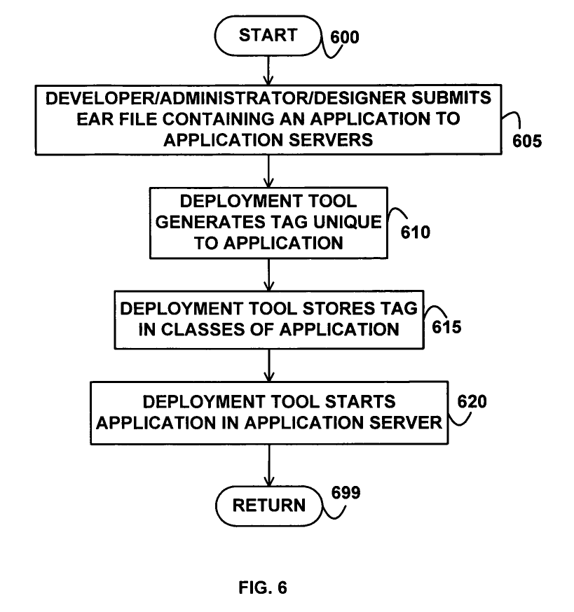

The deployment tool 160 includes instructions capable of executing on the processor 101 or statements capable of being interpreted by instructions executing on the processor 101 to perform the functions as further described below with reference to FIG. 6. In another embodiment, the deployment tool 160 may be implemented in microcode or firmware. In another embodiment, the deployment tool 160 may be implemented in hardware via logic gates and/or other appropriate hardware techniques in lieu of or in addition to a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client 132 may include some or all of the hardware and/or software elements previously described above for the computer system 100. In another embodiment, the client 132 is part of the computer system 100.

It should be understood that FIG. 1 is intended to depict the representative major components of the computer system 100, the network 130, and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media, which include, but are not limited to the following computer-readable media:

(1) information permanently stored on a non-rewriteable storage medium, e.g., a read-only memory storage device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications or transmissions medium, such as through a computer or a telephone network, e.g., the network 130.

Such tangible signal-bearing media, when carrying or encoded with computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

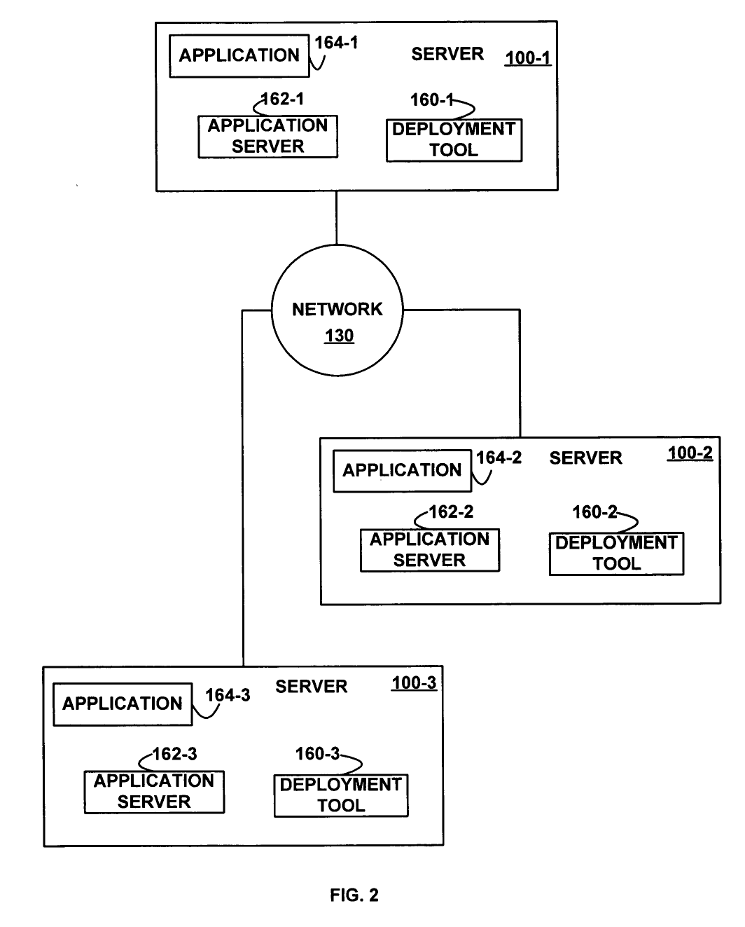

FIG. 2 depicts a block diagram of an example network of servers 100-1, 100-2, and 100-3, according to an embodiment of the invention. The server 100-1 includes a deployment tool 160-1, an application server 162-1, and an application 164-1; the server 100-2 includes a deployment tool 160-2, an application server 162-2, and an application 164-2; and the server 100-3 includes a deployment tool 160-3, an application server 162-3, and an application 164-3. Although each of the servers 100-1, 100-2, and 100-3 is illustrated as including a respective deployment tool 160-1, 160-2, and 160-3, in other embodiments only one or some of the servers may include a deployment tool.

The server 100 (FIG. 1) generically refers to the servers 100-1, 100-2, and 100-3; the deployment tool 160 (FIG. 1) generically refers to the deployment tools 160-1, 160-2, and 160-3; and the application 164 (FIG. 1) generically refers to the applications 164-1, 164-2, and 164-3. Any of the deployment tools 160 may deploy the application 164 to any or all of the application servers 162. The applications 164-1, 164-2, and 164-3 may be the same application, or some or all of them may be different applications. Any number of servers 100, deployment tools 160, application servers 162, and applications 164 may be present.

FIG. 3 depicts a block diagram of the tag data 158, according to an embodiment of the invention. The tag data 158 includes records 305 sand 310, but in other embodiments any number of records with any appropriate data may be present. Each of the records 305 and 310 includes a tag field 315 and a count field 320, but in other embodiments more or fewer fields may be present. The tag field 315 identifies an application 164. In an embodiment, the tag field 315 includes a cryptographic hash of the ear file 154 that contains the application 164, but in other embodiments any appropriate technique for generating unique and consistent tags or identifiers for the applications 164 may be used. The count field 320 includes a count of the number of times that the application server 162 has detected a method associated with or generated on behalf of the application 164 identified by the tag field 315 in the runtime stacks 156. In various embodiments, the tag data 158 may be used for runtime monitoring of the applications 164 in real time or profiling of the applications 164.

FIG. 4 depicts a block diagram of the application 164-1, according to an embodiment of the invention. The application 164-1 includes a class 402 and a service class 404, any number of which may be present. In other embodiments, the application 164-1 may include classes 402 but not service classes 404, or vice versa. The class 402 includes an assigned tag 315-1. The service class 404 includes an assigned tag 315-2 and a stored tag 315-3. The assigned tags 315-1 and 315-2 represent the application 164-1. The stored tag 315-3 represents a different application, e.g., the application 164-2, which requested a service from a method associated with the service class 404 of the application 164-1. The tag 315 (FIG. 3) generically refers to the assigned tags 315-1 and 315-2 and the stored tag 315-3. A class is a formal definition, model, or template that can be instantiated at runtime to create objects with a common definition and therefore, common properties, operations, methods, and behavior. A service class is a class that processes requests from or performs services for other classes. Examples of service classes include web services or RMIs (remote method invocations), but in other embodiments any type of service class may be used.

FIG. 5 depicts a block diagram of the runtime stacks 156, according to an embodiment of the invention. The runtime stacks 156 (also called function stacks, invocation stacks, or call stacks) store information about the functions, subroutines, procedures, methods, and/or classes in the application server 162 and/or the application 164 that are currently being executed by the processor 101. A stack is a data structure that works on the principle of Last In First Out (LIFO), meaning that the last entry put on the stack is the first item that can be taken off. The runtime stacks 156 are stacks because when one method calls another, rather than simply jumping to another part of the application, the current address in the caller method is pushed onto the stack. Its value is then used when the callee method (the method that was called) terminates, by popping the callee method's information off the runtime stack 156 and restoring the program counter back to the value that was stored there.

The runtime stacks 156 includes a stack 505 associated with thread A and a stack 510 associated with thread B, but in other embodiments any number of stacks and any appropriate number of types of entries in the stacks may be present. In an embodiment, a thread is a single sequence of instructions, which may be executed by the processor 101 in parallel with other sequences, either by time slicing or multiprocessing. In another embodiment, a thread is synonymous with a process or a task. In another embodiment, a thread is different from a process in that processes are independent, include state information, have separate address spaces, and interact through system-provided inter-process communication mechanisms, while threads are a technique for splitting a program into two or more simultaneously running tasks, where the threads share the state information of a single process and share memory and other resources directly. In various embodiments, the threads may be implemented via preemptive multithreading, cooperative multithreading, or any other type of multithreading. Preemptive multithreading allows the operating system to determine when a context switch should occur. Cooperative multithreading, on the other hand, relies on the threads themselves to relinquish control once they are at a stopping point.

The stack 505 includes entries 515, 520, 525, and 530, each of which is associated with a respective method. The method associated with the entry 515 called the method associated with entry 520, which called the method associated with entry 525, which called the method associated with the entry 530. The stack 510 includes entries 535, 540, and 535, each of which is associated with a respective method. The method associated with the entry 535 called the method associated with entry 540, which called the method associated with entry 545. Some or all of the entries may include a tag or tags 315, such as the assigned tag 315-4 in the entry 520, the assigned tag 315-5 in the entry 530, the assigned tag 315-6 in the entry 535, and the stored tag 315-7 in the entry 540. The tag 315 (FIG. 3) generically refers to the assigned tags 315-4, 315-5, and 315-6 and to the stored tag 315-7. Some entries may not have tags 315, such as the entries 515, 525, 540, and 545 because they are associated with classes that the application server 162 is not interested in monitoring or profiling. In an embodiment, examples of such classes without tags 315 may include, e.g., Java APIs or classes of the application server itself, but in other embodiments, the application server 162 may insert the tags 315 into every entry in the runtime stacks 156.

FIG. 6 depicts a flowchart of example processing for generating the tag data 158, according to an embodiment of the invention. Control begins at block 600. Control then continues to block 605 where the developer, administrator, or designer submits the ear file 154 to the application server 162. In another embodiment, the ear file 154 may be submitted programmatically. Control then continues to block 610 where the deployment tool 160 generates a tag unique to the application 164. The tag may be generated via a cryptographic hash of the ear file 154 or via any other appropriate technique.

Control then continues to block 615 where the deployment tool 160 stores the tag in the classes of the application 164, e.g., as the assigned tags 315-1 or 315-2, as previously described above with reference to FIG. 4. Control then continues to block 620 where the deployment tool 160 deploys and starts the application 164 in the application server 162. Control then continues to block 699 where the logic of FIG. 6 returns.

FIG. 7 depicts a flowchart of example processing for sampling the application server 162, according to an embodiment of the invention. Control begins at block 700. Control then continues to block 705 where the services implementation 166 enables sampling on each application server 162 in response to a request from an administrator, user, or program. Control then continues to block 710 where the client 132 sends a request to the application server 162.

Control then continues to block 715 where, in response to the request from the client 132, the application server 162 begins processing the request on a thread via the application 164, such as the thread A or thread B (FIG. 5). Control then continues to block 720 where the services implementation 166 samples the runtime stacks 156, finds the class entry nearest the top of the stack that includes an assigned tag (e.g., the entry 520 in the stack 505 or the entry 535 in the stack 510) and retrieves the assigned tag (e.g., the tag 315-4 or the tag 315-6) from the class entry. Control then continues to block 725 where the services implementation 166 determines the application 164 based on the assigned tag. Control then continues to block 730 where the services implementation 166 finds the record, e.g., the record 305 and 310, in the tag data 158 based on the tag 315 and increments the associated count 320. Control then continues to block 799 where the logic of FIG. 7 returns.

FIG. 8 depicts a flowchart of example processing for sampling the application server 162, according to an embodiment of the invention. Control begins at block 800. Control then continues to block 805 where the services implementation 166 enables sampling on each application server 162 in response to a request from an administrator, user, or program. Control then continues to block 810 where a method in the application requests a remote service, e.g., a method associated with the class 402 (FIG. 4). In various embodiments, a remote service request may be a remote method invocation (RMI), a web server request, a SOAP (simple object access protocol) request, or any other appropriate type of remote service request. In various embodiments, the remote service may be on the same or a different server. Control then continues to block 815 where the services implementation 166 finds an assigned tag (e.g., the tag 315-1) in the class 402 associated with the method that requested the remote service and embeds the tag in a remote service request message.

Control then continues to block 820 where the application server 162 sends the remote services request message containing the embedded tag to another remote application server. Control then continues to block 825 where the receiving services implementation 166 receives the remote service request and stores the embedded tag from the remote service request to the stored tag (e.g., the stored tag 315-3) in the service class 404 to which the request is directed. Thus, the service class 404 may now include both an assigned tag 315-2 originally assigned to the service class 404 and a stored tag 315-3, which represents the application 164 that requested a remote service from the service class 404.

Control then continues to block 830 where the services implementation 166 samples the runtime stacks 156, finds the service class entry 535 that is nearest the top of the stack 510, and retrieves the stored tag 315-7 representing the application that requested the service from the service class. Control then continues to block 835 where the services implementation 166 determines the application 164 that requested the service from the service class based on the stored tag 315-7. Control then continues to block 840 where the services implementation 166 finds the associated record in the tag data 158 based on the stored tag 315-7 and increments the associated count 320. Control then continues to block 899 where the logic of FIG. 8 returns.

In this way, the logic of FIGS. 7 and 8 track the application usage of the CPU cycles resource via runtime stack sampling. This runtime stack sampling is based on the premise that samples of the runtime stacks 156 are statistically likely to find the applications 164 in proportion to the amount of CPU cycles that the applications 164 use. For example, if application A uses 30% of the CPU cycles, application B uses 10% of the CPU cycles, and application C uses 60% of the CPU cycles, then over some sufficiently large number of samples, application A is expected to be found in the runtime stack 30% of the time, application B is expected to be found in the runtime stack 10% of the time, and application C is expected to be found 60% of the time. That is, the counts 320 for applications A, B, and C are expected to be in a 3:1:6 ratio. Hence, the ratio of the counts 320 of various applications 164 provides information regarding the resource usage (CPU cycles used) by the applications 164.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
creating a tag that identifies an application;
storing the tag in a class of the application; and
counting a number of times the tag appears in an entry nearest a top of a runtime stack.

2. The method of claim 1, wherein the counting further comprises:
finding an entry nearest a top of a runtime stack that includes the tag; and
incrementing a count associated with the tag in response to the finding.

3. The method of claim 1, wherein the creating is performed in response to submission of the application to an application server.

4. The method of claim 1, wherein the creating further comprises:
creating a cryptographic hash of an archive file that contains the application.

5. The method of claim 1, further comprising:
embedding the tag in a remote service request message in response to a method associated with the class requesting a remote service.

6. The method of claim 5, further comprising:
sending the remote service request message to a remote application server.

7. The method of claim 6, further comprising:
receiving the remote service request message; and
storing the tag in a service class in response to receiving.

8. A signal-bearing medium encoded with instructions, wherein the instructions when executed comprise:
creating a tag that identifies an application;
storing the tag in a class of the application; and
counting a number of times the tag appears in an entry nearest a top of a runtime stack.

9. The signal-bearing medium of claim 8, wherein the counting further comprises:
finding an entry nearest a top of a runtime stack that includes the tag; and
incrementing a count associated with the tag in response to the finding.

10. The signal-bearing medium of claim 8, wherein the creating is performed in response to submission of the application to an application server.

11. The signal-bearing medium of claim 8, wherein the creating further comprises:
creating a cryptographic hash of an archive file that contains the application.

12. The signal-bearing medium of claim 8, further comprising:
embedding the tag in a remote service request message in response to a signal-bearing medium associated with the class requesting a remote service.

13. The signal-bearing medium of claim 12, further comprising:
sending the remote service request message to a remote application server.

14. The signal-bearing medium of claim 13, further comprising:
receiving the remote service request message; and
storing the tag in a service class in response to receiving.

15. A method for configuring a computer, comprising:
configuring the computer to create a tag that identifies an application;
configuring the computer to store the tag in a class of the application; and
configuring the computer to count a number of times the tag appears in an entry nearest a top of a runtime stack.

16. The method of claim 15, wherein the configuring the computer to count further comprises:
configuring the computer to find an entry nearest a top of a runtime stack that includes the tag; and
configuring the computer to increment a count associated with the tag in response to the finding.

17. The method of claim 15, wherein the configuring the computer to create is performed in response to submission of the application to an application server.

18. The method of claim 15, wherein the configuring the computer to create further comprises:
configuring the computer to create a cryptographic hash of an archive file that contains the application.

19. The method of claim 15, further comprising:
configuring the computer to embed the tag in a remote service request message in response to a method associated with the class requesting a remote service.

20. The method of claim 19, further comprising:
configuring the computer to send the remote service request message to a remote application server.
